(19) United States
(12) Patent Application Publication
(10) Pub. No.: US 2023/0038231 A1
(43) Pub. Date: Feb. 9, 2023

(54) HEATED GAS STREAM FOR REDUCING OLIGOMER AND WAX BUILD UP IN RECYCLE COOLERS

(71) Applicant: BOREALIS AG, Vienna (AT)

(72) Inventors: Kenneth Johansson, Stenungsund (SE); Tom Deboel, Zwijndrecht (BE)

(21) Appl. No.: 17/792,819

(22) PCT Filed: Jan. 8, 2021
(86) PCT No.: PCT/EP2021/050267

§ 371 Date: Jul. 14, 2022

(30) Foreign Application Priority Data
Jan. 29, 2020 (EP) 20154265.1
Jan. 29, 2020 (EP) 20154268.5

(51) Int. Cl. C08F 2/00; C08F 2/34; C08F 10/02

(52) U.S. Cl. CPC C08F 2/007; C08F 2/34; C08F 10/02; C08F 2400/04

(57) ABSTRACT

The present invention relates to a process for reducing low molecular weight oligomers and wax build-up in one or more recycle coolers in a high pressure polymerization process by means of a gas stream, which is heated and/or free of wax, introduced into the one or more recycle coolers and the use of a heated gas stream for removing low molecular weight oligomers and wax build-up in one or more recycle coolers in a high pressure polymerization process.

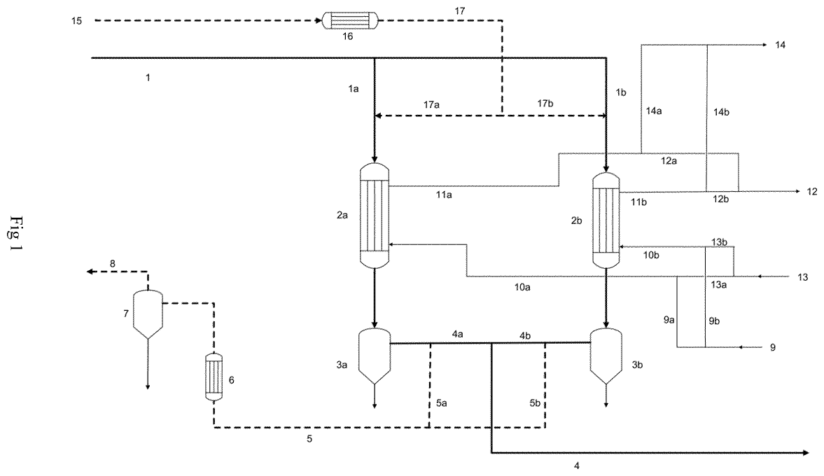

The present invention relates to a process for reducing low molecular weight oligomers and wax build-up in one or more recycle coolers in a high pressure polymerization process by means of a gas stream, which is heated and/or free of wax, introduced into the one or more recycle coolers and the use of a heated gas stream for removing low molecular weight oligomers and wax build-up in one or more recycle coolers in a high pressure polymerization process.

### TECHNICAL BACKGROUND

High pressure polyolefins, such as high pressure low density polyethylene (LDPE) or ethylene vinyl acetate copolymer (EVA), are polymerized in a high pressure free-radical initiated polymerization process, in which the olefin monomers are firstly pressurized to the operating pressure of usually about 100 MPa to 310 MPa and then introduced into the polymerization reactor which can be an autoclave or tubular polymerization reactor. Downstream of the polymerization stage the polymer is separated from a gas stream comprising the unreacted monomers and optional comonomers in a high pressure separator by reducing the pressure to about 200 to 300 barg. The gas stream is then recycled in a high pressure recycle via several cooling and dewaxing steps to the polymerization gas stream.

The high pressure recycle gas stream comprises, apart from unreacted monomers and optional comonomers, also low molecular weight oligomers and wax, which are not separated from the recycle gas stream in the high pressure separator. In the cooling steps these low molecular weight oligomers and wax can precipitate in the recycle coolers and build-up on the inner walls of the coolers. Said build up impairs the heat transfer in the coolers and clog the recycle gas stream passageways in the coolers. In a cooling arrangement of three to four recycle coolers usually especially the second cooler tends to collect low molecular weight oligomers and wax build-up as in the second cooling step the temperature of the recycle gas stream is reduced to about 75-100° C. at which at the given pressure the low molecular weight oligomers and wax in the gas stream tends to precipitate.

In order to restore the heat transfer the low molecular weight oligomers and wax build-up needs to be removed from the inner walls of the recycle cooler. This is usually done by taking the recycle cooler out of service, heating it with heated cooling medium while passing hot recycle gas through the recycle gas stream passageways in the cooler. By introducing heated cooling medium the heat transfer in the recycle cooler is reversed and the low molecular weight oligomers and wax build-up is melted away from the heated inner walls of the recycle cooler.

The drawback of this method of removing the low molecular weight oligomers and wax build-up is that the temperature of inner walls of the recycle cooler can only be adjusted by means of the temperature of the heated cooling medium as the temperature of the hot recycle gas stream can only be manipulated in a small temperature range. Consequently the temperature of the inner walls might not be adjusted to an optimum temperature range for efficiently removing the low molecular weight oligomers and wax build-up. Additionally, the recycle gas itself is saturated with low molecular weight oligomers and wax and thus can only insufficiently take up the melted low molecular weight oligomers and wax build-up.

Thus, there is a need for a more efficient process for removing reducing low molecular weight oligomers and wax build-up in one or more recycle coolers in a high pressure olefin polymerization process.

### SUMMARY OF THE INVENTION

In a first aspect the present invention relates to a process for reducing low molecular weight oligomers and wax build-up in one or more recycle coolers in a high pressure olefin polymerization process comprising the steps of:
a) Heating the cooling medium of one or more recycle coolers to a temperature of more than 50° C. to provide heated cooling medium;
b) Heating the one or more recycle coolers by introducing the heated cooling medium into the passage(s) for the cooling medium;
c) Heating a gas stream to a temperature of from 70 to 250° C., preferably from 130 to 230° C. and most preferably from 160 to 210° C.;
d) Introducing the heated gas stream into the one or more heated recycle coolers through the passage(s) for the fluid to be cooled;
e) Softening low molecular weight oligomers and wax build-up on the inner walls of the passage(s) for the fluid to be cooled of the one or more heated recycle coolers by means of the heated gas stream;
f) Removing the softened low molecular weight oligomers and wax build-up from the passage(s) for the fluid to be cooled of the one or more heated recycle coolers with the heated gas stream.

Additionally, the present invention relates to the use of a gas stream heated to a temperature of from 70 to 250° C. for removing low molecular weight oligomers and wax build-up in one or more recycle coolers in a high pressure olefin polymerization process.

It has been found that with this first aspect of the process of the present invention low molecular weight oligomers and wax build-up can be efficiently removed from the inner walls of the one or more recycle coolers. The gas stream can be heated to an optimum temperature depending on the amount and composition of low molecular weight oligomers and wax build-up to be removed. Additionally, a gas stream can be used which includes only low amounts of low molecular weight oligomers and wax.

In a second aspect the present invention relates to a process for reducing low molecular weight oligomers and wax build-up in one or more recycle coolers in a high pressure olefin polymerization process comprising the steps of:
a) Heating the cooling medium of one or more recycle coolers to a temperature of more than 50° C.;
b) Heating the one or more recycle coolers by introducing the heated cooling medium into the passage(s) for the cooling medium for heating the inner walls of the one or more recycle coolers;
c) Providing a gas stream, which comprises low molecular weight oligomers and wax in an amount of less than 1000 ppm, based on the total weight of the gas stream;
d) Introducing the gas stream into the one or more heated recycle coolers through the passage(s) for the fluid to be cooled;
e) Softening low molecular weight oligomers and wax build-up from the heated inner walls of the one or more recycle coolers by means of the gas stream;
f) Removing the softened low molecular weight oligomers and wax build-up from the passage(s) for the fluid to be cooled of the heated recycle coolers with the gas stream.

Additionally, the present invention relates to the use of a gas stream which comprises low molecular weight oligomers and wax in an amount of less than 1000 ppm, based on the total weight of the gas stream, for removing low molecular weight oligomers and wax build-up in one or more recycle coolers in a high pressure olefin polymerization process.

It has been found that with this second aspect of the process of the present invention low molecular weight oligomers and wax build-up can be efficiently removed from the inner walls of the one or more recycle coolers which are heated in process step (b) for softening the low molecular weight oligomers and wax build-up. The gas stream includes only low amounts of low molecular weight oligomers and wax so that the low molecular weight oligomers and wax build-up in the one or more recycle coolers can be dissolved more efficiently by the gas stream. Additionally, a gas stream can be used which can be heated to an optimum temperature depending on the amount of low molecular weight oligomers and wax build-up to be removed.

### SHORT DESCRIPTION OF THE FIGURE

The FIGURE shows one preferred embodiment of the process of the invention incorporated into the recycling process of a high pressure polymerization process.

### DETAILED DESCRIPTION OF THE INVENTION

In a first aspect the present invention relates to a process for reducing low molecular weight oligomers and wax build-up in one or more recycle coolers in a high pressure olefin polymerization process comprising the steps of:
a) Heating the cooling medium of one or more recycle coolers to a temperature of more than 50° C. to provide a heated cooling medium;
b) Heating the one or more recycle coolers by introducing the heated cooling medium into the passage(s) for the cooling medium;
c) Heating a gas stream to a temperature of from 70 to 250° C., preferably from 130 to 230° C. and most preferably from 160 to 210° C.;
d) Introducing the heated gas stream into the one or more heated recycle coolers through the passage(s) for the fluid to be cooled;
e) Softening low molecular weight oligomers and wax build-up on the inner walls of the passage(s) for the fluid to be cooled of the one or more heated recycle coolers by means of the heated gas stream;
f) Removing the softened low molecular weight oligomers and wax build-up from the passage(s) for the fluid to be cooled of the one or more heated recycle coolers with the heated gas stream.

In a second aspect the present invention relates to a process for reducing low molecular weight oligomers and wax build-up in one or more recycle coolers in a high pressure olefin polymerization process comprising the steps of:
a) Heating the cooling medium of one or more recycle coolers to a temperature of more than 50° C.;
b) Heating the one or more recycle coolers by introducing the heated cooling medium into the passage(s) for the cooling medium for heating the inner walls of the one or more recycle coolers;
c) Providing a gas stream, which comprises low molecular weight oligomers and wax in an amount of less than 1000 ppm, based on the total weight of the gas stream;
d) Introducing the gas stream into the one or more heated recycle coolers through the passage(s) for the fluid to be cooled;
e) Softening low molecular weight oligomers and wax build-up from the heated inner walls of the one or more recycle coolers by means of the gas stream;
f) Removing the softened low molecular weight oligomers and wax build-up from the passage(s) for the fluid to be cooled of the heated recycle coolers with the gas stream.

Both aspects of the present invention are preferably further defined as follows:

The one or more recycle coolers can be arranged in any kind of recycle gas system of the high pressure polymerization process. It is preferred that the one or more recycle coolers are arranged in the high pressure recycle gas system for recycling the gas stream separated from the polyolefin stream in a high pressure separator.

The recycle gas system, preferably the high pressure recycle gas system, can comprise one or more, preferably two or more, such as 2, 3, 4 or 5 cooling steps, more preferably 3, 4 or 5 cooling steps and most preferably 4 cooling steps.

The one or more recycle coolers can be arranged in any cooling step of the high pressure recycle process. Preferably the one or more recycle coolers are arranged in the second, third or fourth cooling step of the high pressure recycle gas system, more preferably the second or third cooling step of the high pressure recycle gas system, and most preferably in the second cooling step of the high pressure recycle gas system.

In one embodiment the one or more recycle coolers can be one recycle cooler.

In another embodiment the one or more recycle coolers can be more than one recycle cooler such as 2, 3, 4, 5 or 6, preferably 2, 3 or 4 recycle coolers and most preferably 2 recycle coolers.

The one or more recycle coolers can be a single recycle cooler in a cooling stage.

In another embodiment the one or more recycle coolers is one recycle cooler in an arrangement of two recycle coolers in parallel flow mode in a cooling stage.

Preferably in a recycle gas system comprising two or more cooling steps, such as a high pressure recycle gas system comprising two or more cooling steps, preferably 3, 4, or 5 cooling steps and most preferably 4 cooling steps, at least in the second cooling step the one or more recycle coolers is one recycle cooler in an arrangement of two recycle coolers in parallel flow in a cooling stage.

In step a) of the present invention the cooling medium is heated to a temperature of more than 50° C., preferably from 60 to 200° C., still more preferably from 80 to 190° C. and most preferably from 100 to 180° C. to provide a heated cooling medium. In one embodiment the temperature of the cooling medium can be adjusted to the amount of low molecular weight oligomers and wax build-up in the one or more recycle coolers.

The cooling medium can be any cooling medium suitable for heat transfer in a heat exchanger such as the one or more recycle cooler. The cooling medium thereby should be liquid in the above described temperature range. Suitable cooling mediums are water or organic liquids such as alcohols, aldehydes, ketones etc, or mixtures thereof. Mostly preferred is water.

The heated cooling medium can be taken from any stream of cooling medium used in the polymerization process or can be taken from a fresh source of cooling medium. Thereby, the temperature of the cooling medium can be individually adjusted to the required temperature by means of a heating source. It is preferred that the heated cooling medium is taken from stream in the high pressure polymerization process which already is in the required temperature range so that no additional heating source is needed.

In process step b) the heated cooling medium is introduced into the passageway(s) for the cooling medium of the one or more recycle coolers. Thereby, heat is transferred from the heated cooling medium to the inner walls of the one or more recycle coolers onto which the low molecular weight oligomers and wax has built up.

Preferably, the low molecular weight oligomers and wax is softened on the heated inner walls of the one or more recycle coolers.

In process step c) of the first aspect a gas stream is heated to a temperature of from 70 to 250° C., preferably from 130 to 230° C. and most preferably from 160 to 210° C.

Said heated gas stream is then introduced into the one or more recycle coolers through the passage(s) for the fluid to be cooled in process step d).

In process step e) the heated gas stream is then softening low molecular weight oligomers and wax build-up on the inner walls of the passage(s) for the fluid to be cooled of the one or more heated recycle coolers.

The low molecular weight oligomers and wax build-up are usually softened by heating the low molecular weight oligomers and wax build-up, preferably to a temperature in the range of below the melting temperature to above the melting temperature of the low molecular weight oligomers and wax build-up. Preferably, at least part of the low molecular weight oligomers and wax build-up is melted upon softening.

The softening of the low molecular weight oligomers and wax build-up is suitable for improving removal of the softened low molecular weight oligomers and wax build-up from the passage(s) for the fluid to be cooled of the one or more heated recycle coolers with the heated gas stream in process step f).

This process step is supported by the heating of the one or more recycle cooler by means of the heated cooling medium in process step b).

The gas stream can be heated to a temperature of from 70 to 250° C., preferably from 130 to 230° C. and most preferably from 160 to 210° C. individually depending on the amount of low molecular weight oligomers and wax build-up that needs to be reduced in the one or more recycle coolers.

The gas stream can be any gas stream suitable for being heated to the above described temperature range. The gas stream thereby should be gaseous in the above described temperature range.

Suitable gas streams can be a polymerization gas stream upstream from the polymerization process, a recycle gas stream downstream of the high pressure separator, such as a high pressure recycle gas stream or a low pressure recycle gas stream, air or nitrogen. Preferably the gas stream is a polymerization gas stream upstream from the polymerization process or a recycle gas stream downstream of the high pressure separator, such as a high pressure recycle gas stream or a low pressure recycle gas stream.

It is preferred that the gas stream comprises olefin monomers in an amount of at least 90 wt %, more preferably at least 95 wt % and most preferably at least 98 wt %, based on the total weight of the gas stream.

Most preferred is a polymerization gas stream upstream from the polymerization process. The polymerization gas stream is preferably a gas stream discharged for one compressor upstream of the polymerization reactor. In a two step compressor arrangement the polymerization gas stream is preferably a gas stream discharged for the first compressor, which usually is a primary compressor.

The gas stream discharged from the compressor preferably has a pressure of from 100 to 300 barg, depending on the polymerization reactor. For an autoclave reactor the pressure is preferably in the range of from 100 to 200 barg, preferably from 120 to 185 bar and most preferably from 140 to 170 barg. For a tubular reactor the pressure is preferably in the range of from 200 to 300 barg, more preferably from 225 to 285 barg and most preferably from 250 to 270 barg, such as around 260 barg. The gas stream discharged from the compressor preferably has a temperature of from 50 to 150° C., more preferably from 65 to 135° C. and most preferably from 80 to 110° C.

The gas stream is preferably introduced into a heating system for heating the gas stream to the required temperature.

The pressure of the gas stream is preferably not manipulated before introducing into the one or more recycle coolers.

Thus, when using gas stream discharged from the first compressor, such as the primary compressor, upstream of the polymerization reactor the gas stream preferably has a pressure a pressure of from 100 to 300 barg, depending on the polymerization reactor as described above.

Preferably, the gas stream comprises low amounts of low molecular weight oligomers and wax, such as not more than 1000 ppm, more preferably not more than 500 ppm, and most preferably not more than 300 ppm, based on the total weight of the gas stream.

In some embodiments it is preferred that the gas stream in process step c) comprises low molecular weight oligomers and wax in an amount of less than 100 ppm, such as in the range of 1 to 50 ppm, more preferably 2 to 25 ppm and still more preferably 5 to 10 ppm, based on the total weight of the gas stream.

It is especially preferred that the gas stream comprises not detectable amounts of low molecular weight oligomers and wax, based on the total weight of the gas stream.

In process step c) of the second aspect a gas stream is provided, which comprises low molecular weight oligomers and wax in an amount of less than 1000 ppm, preferably not more than 500 ppm, and most preferably not more than 300 ppm, based on the total weight of the gas stream.

In some embodiments it is preferred that the gas stream in process step c) comprises low molecular weight oligomers and wax in an amount of less than 100 ppm, such as in the range of 1 to 50 ppm, more preferably 2 to 25 ppm and still more preferably 5 to 10 ppm, based on the total weight of the gas stream.

It is preferred that said gas stream is free from detectable amounts of low molecular weight oligomers and wax.

The gas stream can be any gas stream, which comprises low molecular weight oligomers and wax in an amount of less than 1000 ppm, based on the total weight of the gas stream or is free from detectable amounts of low molecular weight oligomers and wax.

Suitable gas streams can be a polymerization gas stream upstream from the polymerization process, a recycle gas stream downstream of the high pressure separator, such as a high pressure recycle gas stream or a low pressure recycle gas stream, air or nitrogen. Preferably the gas stream is a polymerization gas stream upstream from the polymerization process or a recycle gas stream downstream of the high pressure separator, such as a high pressure recycle gas stream or a low pressure recycle gas stream.

It is preferred that the gas stream comprises olefin monomers in an amount of at least 90 wt %, more preferably at least 95 wt % and most preferably at least 98 wt %, based on the total weight of the gas stream.

Most preferred is a polymerization gas stream upstream from the polymerization process. The polymerization gas stream is preferably a gas stream discharged for one compressor upstream of the polymerization reactor. In a two step compressor arrangement the polymerization gas stream is preferably a gas stream discharged from the first compressor, which usually is a primary compressor.

The gas stream discharged from the compressor preferably has a pressure of from 100 to 300 barg, depending on the polymerization reactor. For an autoclave reactor the pressure is preferably in the range of from 100 to 200 barg, preferably from 120 to 185 bar and most preferably from 140 to 170 barg. For a tubular reactor the pressure is preferably in the range of from 200 to 300 barg, more preferably from 225 to 285 barg and most preferably from 250 to 270 barg, such as around 260 barg.

The gas stream discharged from the compressor preferably has a temperature of from 50 to 150° C., more preferably from 65 to 135° C. and most preferably from 80 to 110° C.

The gas stream can be heated to a temperature of from 70 to 250° C., preferably from 130 to 230° C. and most preferably from 160 to 210° C.

The gas stream can be heated to a temperature of from 70 to 250° C., preferably from 130 to 230° C. and most preferably from 160 to 210° C. individually depending on the amount of low molecular weight oligomers and wax build-up that needs to be reduced in the one or more recycle coolers.

For heating the gas stream, the gas stream is preferably introduced into a heating system for heating the gas stream to the wanted temperature.

The gas stream is then introduced into the one or more heated recycle coolers through the passage(s) for the fluid to be cooled in process step d).

The pressure of the gas stream is preferably not manipulated before introducing into the one or more recycle coolers.

Thus, when using gas stream discharged for the first compressor, such as the primary compressor, upstream of the polymerization reactor the gas stream preferably has a pressure a pressure of from 100 to 300 barg, depending on the polymerization reactor as described above.

In process step e) the low molecular weight oligomers and wax build-up is softened on the heated inner walls of the one or more recycle coolers by means of the gas stream.

The low molecular weight oligomers and wax build-up are usually softened by heating the low molecular weight oligomers and wax build-up, preferably to a temperature in the range of below the melting temperature to above the melting temperature of the low molecular weight oligomers and wax build-up. Preferably, at least part of the low molecular weight oligomers and wax build-up is melted upon softening.

The softening of the low molecular weight oligomers and wax build-up is suitable for improving removal of the softened low molecular weight oligomers and wax build-up from the passage(s) for the fluid to be cooled of the one or more heated recycle coolers with the heated gas stream in process step f).

This process step is supported by the heating of the one or more recycle cooler by means of the heated cooling medium in process step b).

In both aspects, after removing the softened low molecular weight oligomers and wax build-up from the passage(s) for the fluid to be cooled of the one or more heated recycle coolers with the heated gas stream in process step f) the heated gas stream comprising the softened low molecular weight and wax build-up is preferably introduced into a separating vessel to separate the softened low molecular weight and wax build-up from the heated gas stream such as a wax separator or de-waxer. The softened low molecular weight and wax build-up can then be treated or recycled in the same way as other sources of low molecular weight and wax build-up.

The optionally heated gas stream which exits the separating vessel can either be recycled within the high pressure polymerization process or can be discarded. Preferably, the optionally heated gas stream is discarded in a purging step. Before entering the purging vessel the optionally heated gas stream can still be used in a heat exchanger as a heating medium for heating another stream in the high pressure process. The optionally heated gas stream can also be introduced into an additional separating vessel before entering the purging vessel for removing residual softened low molecular weight and wax build-up.

The process of the present invention as described above or below can be used in a high pressure polymerization arrangement which is shut down e.g. for maintenance.

The process of the present invention as described above or below can be used in a high pressure polymerization arrangement during operation.

When using the process as described herein during operation the process is preferably used in a cooling step of a recycle gas system in which two recycle coolers are arranged in a parallel flow mode.

It is preferred that in the high pressure recycle gas system which comprises two or more cooling steps, preferably 3, 4 or 5 cooling steps, most preferably 4 cooling steps each of the second or more cooling steps, such as the second and third cooling step or only the second cooling step comprises at least two recycle coolers, preferably two recycle coolers, which are arranged in parallel flow mode.

It is thereby preferred that in such an arrangement of at least two, preferably two recycle coolers in parallel flow mode arrangement from one of the at least two recycle coolers, preferably one of the two recycle coolers, the low molecular weight oligomers and wax build-up is removed by means of the process as described herein, whereas the other(s) of the at least two recycle coolers, preferably the other of the two recycle coolers, is in operation mode to cool the recycle gas stream.

After removing low molecular weight oligomers and wax build-up from the one of the at least two recycle coolers, preferably from the one of the two recycle coolers, the flow directions are preferably switched so that said one of the at least two recycle coolers, preferably from said one of the two recycle coolers, from which the low molecular weight oligomers and wax build-up is removed is switched to operation mode to cool the recycle gas stream, whereas the other from of the at least two recycle coolers, preferably from the other of the two recycle coolers, is switched from operation mode to the process for reducing low molecular weight oligomers and wax build-up.

In such an arrangement, low molecular weight oligomers and wax build-up can be effectively removed from one recycle cooler during operation.

It is preferred that the process according to the present invention is used in a continuous high pressure polymerization process.

Additionally, in the first aspect the present invention relates to the use of a gas stream heated to a temperature of from 70 to 250° C. for removing low molecular weight oligomers and wax build-up in one or more recycle coolers in a high pressure olefin polymerization process.

In the second aspect the present invention relates to the use of a gas stream which comprises low molecular weight oligomers and wax in an amount of less than 1000 ppm, based on the total weight of the gas stream, for removing low molecular weight oligomers and wax build-up in one or more recycle coolers in a high pressure olefin polymerization process.

Preferably, said gas stream is free from detectable amounts of low molecular weight oligomers and wax.

Thereby, in both aspects the gas stream, the one or more recycle coolers and the high pressure olefin polymerization process in said used preferably include all embodiments of the gas stream, the one or more recycle coolers and the high pressure olefin polymerization process as described herein.

It is preferred for both aspects that the gas stream is used for removing low molecular weight oligomers and wax build-up in one or more recycle coolers in a high pressure olefin polymerization process in accordance with the process for reducing low molecular weight oligomers and wax build-up in one or more recycle coolers in a high pressure olefin polymerization process as described above or below

### REFERENCE SIGNS IN FIGURE

1 hot recycle stream
1a hot recycle stream to recycle cooler A
1b hot recycle stream to recycle cooler B
2a recycle cooler A
2b recycle cooler B
3a wax separator A
3b wax separator B
4a dewaxed recycle stream from wax separator A
4b dewaxed recycle stream from wax separator B
4 dewaxed recycle stream
5a dewaxed side stream from wax separator A
5b dewaxed side stream from wax separator B
5 dewaxed side stream
6 purge gas cooler
7 purge gas wax separator
8 dewaxed purge gas stream
9 cold cooling medium stream
9a cold cooling medium stream to recycle cooler A
9b cold cooling medium stream to recycle cooler B
10a cooling medium stream to recycle cooler A
10b cooling medium stream to recycle cooler B
11a cooling medium stream from recycle cooler A
11b cooling medium stream from recycle cooler B
12a cold cooling medium stream from recycle cooler A
12b cold cooling medium stream from recycle cooler B
12 cold cooling medium stream
13 heated cooling medium stream
13a heated cooling medium stream to recycle cooler A
13b heated cooling medium stream to recycle cooler B
14a heated cooling medium stream from recycle cooler A
14b heated cooling medium stream from recycle cooler B
14 heated cooling medium stream
15 softening gas stream
16 softening gas heater
17 heated softening gas stream
17a heated softening gas stream to recycle cooler A
17b heated softening gas stream to recycle cooler B

### DETAILED DESCRIPTION OF THE FIGURE

The FIGURE shows one preferred embodiment of the process of the invention incorporated into the recycling process of a high pressure polymerization process. In a high pressure polymerization process the recycle stream, which includes the unreacted monomers and optional comonomers and low molecular weight oligomers and wax, are transported in the hot recycle stream (1) from the upstream process to the cooling step. The upstream process thereby can either be the high pressure separation step so that the present cooling step is the first cooling step in the recycling process or the an upstream cooling step so that the present cooling step is the second cooling step in the recycling process. Usually the process of the invention will be implemented in the second cooling step so that the hot recycle stream (1) directs the recycle stream from the first cooling step to the second cooling step. The cooling step includes two sets of recycle coolers (2a/b) and downstream wax separators (3a/b) in parallel arrangement. The hot recycle stream (1) is directed only through one set of recycle cooler A (2a) and downstream wax separator A (3a) through the hot recycle stream (la). When the set of recycle cooler A (2a) and downstream wax separator A (3a) is used for cooling the product stream (1) the other set of recycle cooler B (2b) and downstream wax separator B (3b) is not used for this purpose and vice versa. The recycle stream (1) can be switched between recycle streams (la) and (lb) in order to switch between the two sets of recycle coolers (2a/b) and downstream wax separators (3a/b). When in use for cooling the recycle stream (1) recycle cooler A (2a) is cooled by the cooling medium stream (9), which is introduced via stream (9a) and (10a) into the recycle cooler's passage(s) for the cooling medium. The heat of the hot recycle stream (1) is transferred in the recycle cooler A (2a) to the cooling medium, which is transported from the recycle cooler A (2a) via streams (11a), (12a) and (12). The cooled recycle stream is transferred to the wax separator (3a) in which the low molecular weight oligomers and wax build-up are separated from the recycle stream. The de-waxed recycle stream is transferred to the downstream recycle processes and eventually re-introduced into the polymerization process via stream (4).

In said second cooling step the recycle stream (1) has a temperature of preferably 175° C. and a pressure of preferably 250 barg. The de-cooled recycle stream has a temperature of preferably 80° C. and a pressure of preferably 250 barg. In the recycle cooler A (2a) during cooling of the recycle stream the low molecular weight oligomers and wax in the recycle stream tend to precipitate on the inner walls of the recycle cooler A (2a) and gradually clog the passage ways of the recycle cooler A (2a) and impairs the heat transfer.

In order to remove the low molecular weight oligomers and wax precipitate from the inner walls of the recycle cooler A (2a) the product stream (1) is switched from stream (la) to stream (lb) so that the product stream (1) is now transferred through the set of recycle cooler B (2b) and downstream wax separator B (3b) and the set of recycle cooler A (2a) and downstream wax separator A (3a) lies dormant.

Dormant recycle cooler A (2a) can now be de-waxed by the process of the invention. In a first step the recycle cooler A (2a) is heated by introducing heated cooling medium (13) into the recycle cooler's passage(s) for the cooling medium via streams (13a) and (10a). The heated cooling medium leaves the recycle cooler A (2a) via streams (11a), (14a) and (14). The heated cooling medium has a temperature of more than 50° C., preferably 100 to 180° C., when entering the recycle cooler's passage(s) for the cooling medium via stream (10a).

In a second step a softening gas stream (15) is optionally heated to a temperature of from 70 to 250° C., preferably from 130 to 230° C., most preferably from 160 to 210° C. in the softening gas heater (16). Thereby, the softening gas can be heated to an optimum temperature within the above temperature range depending on the amount of precipitated low molecular weight oligomers and wax.

The softening gas stream (15) can be separated from any kind of gas stream in the high pressure polymerization process. The softening gas optionally comprises only minimal amounts of low molecular weight oligomers and wax, namely less than 1000 ppm, preferably less than 500 ppm, and most preferably less than 300 ppm and is some embodiments less than 100 ppm, such as in the range of 1 to 50 ppm, more preferably 2 to 25 ppm and most preferably 5 to 10 ppm, based on the total weight of the gas stream, most preferably is free of low molecular weight oligomers and wax.

In one preferred embodiment the softening gas stream (15) is separated from the polymerization gas stream downstream the compressor, preferably downstream the first compressor in a two-step compressor arrangement, and has a temperature of from preferably 50 to 150° C., more preferably from 65 to 135° C. and most preferably from 80 to 110° C. and a pressure of from 100 to 300 barg, preferably in the range of from 100 to 200 barg, preferably from 120 to 185 bar and most preferably from 140 to 170 barg when using an autoclave reactor or preferably in the range of from 200 to 300 barg, more preferably from 225 to 285 barg and most preferably from 250 to 270 barg, such as around 260 barg, when using a tubular reactor. It is optionally thereafter heated to a temperature suitable for dewaxing of the recycle cooler as discussed above.

The optionally heated softening gas stream (17) is introduced into the heated recycle cooler A (2a) via streams (17a) and (la). In the heated recycle cooler A (2a) the optionally heated softening gas softens the precipitated low molecular weight oligomers and wax on the inner walls of the recycle cooler A (2a) and transports the softened low molecular weight oligomers and wax out of the recycle cooler A (2a) into the wax separator A (3a). This process step is supported by the heating of the recycle cooler A (2a) by means of the heated cooling medium as the heated cooling medium already transfers heat and warms up the inner walls of the recycle cooler A (2a).

In the wax separator A (3a) the softened low molecular weight oligomers and wax is separated from the softening gas stream. The de-waxed softening gas stream is transferred via streams (4a), (5a) and (5) into a further cooler (6) and wax separator (7) for separating residual low molecular weight oligomers and wax into purge gas stream (8) which is transferred to the downstream purging process.

### BENEFITS OF THE INVENTION

The process of the present invention shows an efficient method of cleaning the recycle cooler from precipitated low molecular weight oligomers and wax.

By heating the softening gas to an optimum temperature depending on the amount of precipitated low molecular weight oligomers and wax the precipitate can be efficiently removed from the inner walls of the recycle cooler.

By using a softening gas with an of low molecular weight oligomers and wax of less than 1000 ppm, based on the total weight amount of the softening gas, preferably without any detectable amount of low molecular weight oligomers and wax the precipitate can be efficiently removed from the inner walls of the recycle cooler. With the embodiment of the inventive process shown in the FIGURE it is not necessary in a continuous high pressure polymerization process to stop the recycling process for cleaning the recycle cooler. Instead in the parallel arrangement of two sets of recycle coolers and wax separators the recycle process can be switched from one set to the other set and the dormant set can be cleaned.

1. A process for reducing low molecular weight oligomers and wax build-up in one or more recycle coolers in a high pressure olefin polymerization process comprising the steps of:
a) heating the cooling medium of one or more recycle coolers to a temperature of more than 50° C. to provide heated cooling medium;
b) heating the one or more recycle coolers by introducing the heated cooling medium into the passage(s) for the cooling medium;
c) heating a gas stream to a temperature of from 70 to 250° C.;
d) introducing the heated gas stream into the one or more heated recycle coolers through the passage(s) for the fluid to be cooled;
e) softening low molecular weight oligomers and wax build-up on the inner walls of the passage(s) for the fluid to be cooled of the one or more heated recycle coolers by means of the heated gas stream;
f) removing the softened low molecular weight oligomers and wax build-up from the passage(s) for the fluid to be cooled of the one or more heated recycle coolers with the heated gas stream.

2. The process according to claim 1, wherein the gas stream is heated to a temperature in the range of from 70 to 250° C. depending on the amount of reducing low molecular weight oligomers and wax build-up in one or more recycle coolers.

3. The process according to claim 1, wherein the gas stream comprises low molecular weight oligomers and wax in an amount of less than 1000 ppm, based on the total weight of the gas stream.

4. The process according to claim 1, wherein the gas stream is free from detectable amounts of low molecular weight oligomers and wax.

5. A process for reducing low molecular weight oligomers and wax build-up in one or more recycle coolers in a high pressure olefin polymerization process comprising the steps of:
a) heating the cooling medium of one or more recycle coolers to a temperature of more than 50° C.;
b) heating the one or more recycle coolers by introducing the heated cooling medium into the passage(s) for the cooling medium for heating the inner walls of the one or more recycle coolers;
c) providing a gas stream, which comprises low molecular weight oligomers and wax in an amount of less than 1000 ppm, based on the total weight of the gas stream;
d) introducing the gas stream into the one or more heated recycle coolers through the passage(s) for the fluid to be cooled;
e) softening low molecular weight oligomers and wax build-up on the heated inner walls of the one or more recycle coolers by means of the gas stream;
f) removing the softened low molecular weight oligomers and wax build-up from the passage(s) for the fluid to be cooled of the heated recycle coolers with the gas stream.

6. The process according to claim 5, wherein the gas stream is free from detectable amounts of low molecular weight oligomers and wax.

7. The process according to claim 5, wherein the gas stream discharged from the primary compressor is heated to a temperature of from 70 to 250° C. and the heated gas stream is introduced into the one or more heated recycle coolers.

8. The process according to claim 7, wherein the gas stream is heated to a temperature in the range of from 70 to 250° C. depending on the amount of reducing low molecular weight oligomers and wax build-up in one or more recycle coolers.

9. The process according to claim 1, wherein the gas stream comprises olefin monomers in an amount of at least 90 wt %, based on the total weight of the gas stream.

10. The process according to claim 1, wherein the gas stream is separated from the gas stream discharged from the primary compressor of the high pressure polymerization process and optionally introduced to a heating system to produce the heated gas stream.

11. The process according to claim 10, wherein the gas stream is separated from the gas stream discharged from the primary compressor has a pressure of from 100 to 300 barg and a temperature of from 50 to 150° C. before optionally being introduced to a heating system to produce the heated gas stream.

12. The process according to claim 1, wherein the heated gas stream comprising the softened low molecular weight oligomers and wax build-up exiting the one or more heated recycle coolers is introduced into a separating vessel to separate the softened low molecular weight oligomers and wax build-up from the heated gas stream.

13. The process according to claim 1, wherein the one or more recycle coolers are situated in the high pressure recycle gas system for recycling the gas stream separated from the polyolefin stream in a high pressure separator.

14. The process according to claim 13, wherein the high pressure recycle gas system comprises two or more cooling steps and the one or more recycle coolers are situated in the second or more cooling steps.

15. The process according to claim 14, wherein each of the second or more cooling steps comprises at least two recycle coolers arranged in parallel flow mode.

16. The process according to claim 15, wherein from one of the at least two recycle coolers the low molecular weight oligomers and wax build-up is removed whereas the other of the at least two recycle coolers is in operation mode to cool the recycle gas stream.

17. The process according to claim 16, wherein after removing low molecular weight oligomers and wax build-up from the one of the at least two recycle coolers the flow directions are switched so that said one of the at least two recycle coolers from which the low molecular weight oligomers and wax build-up is removed is switched to operation mode to cool the recycle gas stream, whereas the other from of the at least two recycle coolers is switched from operation mode to the process for reducing low molecular weight oligomers and wax build-up according to any one of the preceding claims.

18. The process according to claim 1, being conducted in a continuous high pressure olefin polymerization process during operation.

19. (canceled)

20. (canceled)

21. The process according to claim 4, wherein the gas stream comprises olefin monomers in an amount of at least 90 wt %, based on the total weight of the gas stream.

22. The process according to claim 4, wherein the gas stream is separated from the gas stream discharged from the primary compressor of the high pressure polymerization process and optionally introduced to a heating system to produce the heated gas stream.
